(19) United States
(12) Patent Application Publication
(10) Pub. No.: US 2023/0195533 A1
(43) Pub. Date: Jun. 22, 2023

(54) PREPOPULATING PAGE TABLES FOR MEMORY OF WORKLOADS DURING LIVE MIGRATIONS

(71) Applicant: VMware, Inc., Palo Alto, CA (US)

(72) Inventors: Yury BASKAKOV, Newton, MA (US); Ying YU, Bellevue, WA (US); Anurekh SAXENA, Newcastle, WA (US); Arunachalam RAMANATHAN, Union City, CA (US); Frederick Joseph JACOBS, Los Gatos, CA (US); Giritharan RASHIYAMANY, Mountain View, CA (US)

(21) Appl. No.: 17/559,625

(22) Filed: Dec. 22, 2021

(51) Int. Cl. G06F 9/50; G06F 12/1009; G06F 12/0882; G06F 12/02

(52) U.S. Cl. CPC G06F 9/5077; G06F 9/5016; G06F 12/1009; G06F 12/0882; G06F 12/0238; G06F 2212/7201

(57) ABSTRACT

A method of populating page tables of an executing workload during migration of the executing workload from a source host to a destination host includes the steps of: during transmission of memory pages of the executing workload from the source host to the destination host, populating the page tables of the workload at the destination host, wherein the populating comprises inserting mappings from virtual addresses of the workload to physical addresses of system memory of the destination host for all of the memory pages of the executing workload; and upon completion of transmission of all of the memory pages of the workload, resuming the workload at the destination host.

### BACKGROUND

In a virtualized computing system, a computing platform of a physical host may be encapsulated into virtual machines (VMs) running applications. A VM abstracts the processing, memory, storage, and the like of the computing platform for a guest operating system (OS) of the VM. Virtualization software on a host, also referred to as a “hypervisor,” provides an execution environment for VMs, and a virtualization manager migrates VMs between hosts. Such migrations may be performed “live,” i.e., while VMs are running. For such live migrations, one goal is to migrate VMs with minimal impact on performance.

Prior to a “switch-over” in which a VM is “quiesced” on a source host and resumed on a destination host, various operations are performed on the VM. Such operations include copying the state of the VM's memory from the source host to the destination host. However, until the VM is switched over to the destination host, the VM continues executing applications at the source host. During this execution, some of the memory of the source host that is copied to the destination host is later modified by the VM at the source host. As such, an iterative “pre-copying” phase may be used in which at a first iteration, all the VM's memory is copied from the source host to the destination host. Then, during each subsequent iteration, memory of the source host that has been modified is copied again to the destination host.

During the pre-copying phase, the VM's memory may be copied to the destination host in relatively small units. e.g., in 4-KB “pages.” The use of small units reduces the amplification of “dirty” data by isolating the modifications made between iterations to smaller units of memory. For example, if a few modifications are made in a certain memory region, it is preferable to only retransmit a few 4-KB pages that contain the modifications than to retransmit an entire, e.g., 2-MB page that contains the modifications.

Although the VM's memory may be copied to the destination host in relatively small units, the hypervisors of the source and destination hosts may employ virtual memory spaces that divide memory into larger units. For example, the VM may employ a virtual address space that divides memory into “small” 4-KB pages. However, the hypervisors may employ separate virtual address spaces that divide memory into “large” 2-MB pages, each large page containing 512 contiguous 4-KB pages.

Use of large pages is generally advantageous for virtual memory system performance. For an application of a VM to touch system memory of the destination host, the application may issue an input/output operation (IO) to a virtual address of the VM, also referred to as a “guest virtual address.” The guest virtual address may be translated into a physical memory address of system memory by “walking.” i.e., traversing two sets of page tables that contain mapping information: a first set maintained by the VM and a second set maintained by the hypervisor. The page tables maintained by the hypervisor are referred to as “nested” page tables. To speed up translation, a translation lookaside buffer (TLB) may be utilized that contains beginning-to-end mappings of guest virtual addresses to physical memory addresses. However, such a TLB is limited in size and thus only contains some mappings, e.g., those of recently-accessed guest virtual addresses. When an application requests to access memory at a guest virtual address for which the TLB contains no mapping, a “TLB miss” occurs, and the page tables must be walked. Use of relatively large pages minimizes the number of TLB misses and thus minimizes the number of expensive page-table walks.

When a VM is migrated to a destination host, the nested page tables of the destination host do not contain mappings from the VM's address space to physical memory addresses of the destination host. As such, in existing systems, once the VM resumes on the destination host and begins accessing memory at various virtual addresses, new mappings must be created on demand. Creating such mappings on demand often significantly degrades VM performance for extended periods of time, especially for memory-intensive VMs that touch memory rapidly. A method is needed that improves the responsiveness of VMs after migrations.

### SUMMARY

Accordingly, one or more embodiments provide a method of populating page tables of an executing workload during migration of the executing workload from a source host to a destination host. The method includes the steps of: during transmission of memory pages of the executing workload from the source host to the destination host, populating the page tables of the workload at the destination host, wherein the populating comprises inserting mappings from virtual addresses of the workload to physical addresses of system memory of the destination host for all of the memory pages of the executing workload; and upon completion of transmission of all of the memory pages of the workload, resuming the workload at the destination host.

Further embodiments include a non-transitory computer-readable storage medium comprising instructions that cause a host to carry out the above method, as well as a computer system configured to carry out the above method.

### BRIEF DESCRIPTION OF THE DRAWINGS

FIG. 1 is a block diagram of a host computer that may be used for a live migration of a VM, according to embodiments.

FIG. 2A is a block diagram of memory page tables in a page table hierarchy, according to embodiments.

FIG. 2B is a block diagram illustrating an example of an address that may be used to walk memory page tables, according to embodiments.

FIG. 3 is a block diagram of a virtualized computing system in which a VM may be migrated from a source host to a destination host, according to embodiments.

FIG. 4 is a flow diagram of steps carried out by a source host to perform a method of migrating a VM, according to embodiments.

FIG. 5 is a flow diagram of steps carried out by a destination host to perform a method of migrating a VM, according to embodiments.

### DETAILED DESCRIPTION

Techniques for improving the responsiveness of VMs after migration are described. The techniques involve prepopulating nested page tables of a destination host with mappings from the host virtual address space allocated for the VM to host physical memory addresses before resuming the VM. Such prepopulating of page tables eliminates the need for page fault handling upon the resumption of the VM. Furthermore, such prepopulating is performed in parallel with the copying of memory pages from the source host to the destination host. As such, the prepopulating can be completed for all the memory pages of an executing VM without any VM downtime.

Although the disclosure is described with reference to VMs, the teachings herein also apply to nonvirtualized applications and to other types of virtual computing instances such as containers, Docker® containers, data compute nodes, isolated user space instances, and the like for which a virtual memory environment may benefit from prepopulating page tables before resuming a workload at a destination host. These and further aspects of the invention are discussed below with respect to the drawings.

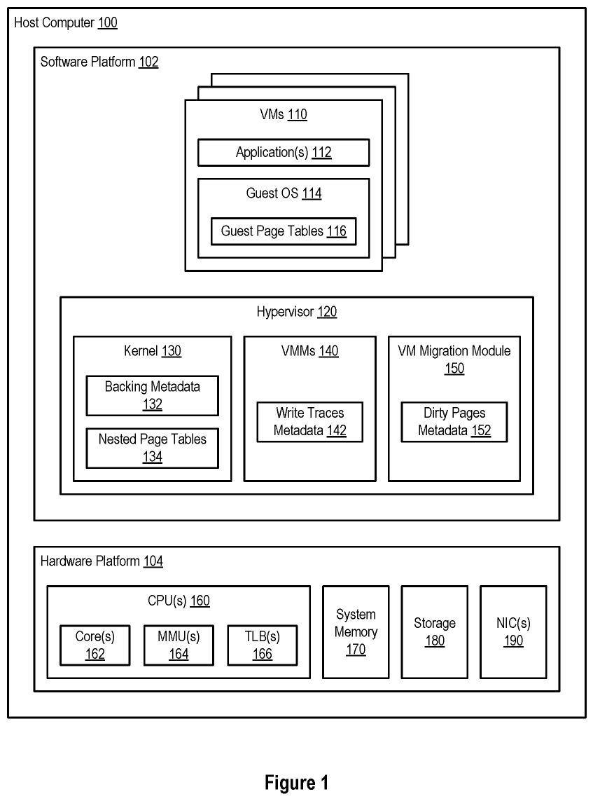

FIG. 1 is a block diagram of a host computer (also referred to as “host” for short) 100 that may be used for a live migration of a VM 110, according to embodiments. Host 100 may be a physical computer server constructed on a server grade hardware platform 104 such as an x86 architecture platform.

Hardware platform 104 includes conventional components of a computing device, such as one or more central processing units (CPUs) 160, system memory 170 such as random-access memory (RAM), optional local storage 180 such as one or more hard disk drives (HDDs) or solid-state drives (SSDs), and one or more network interface cards (NICs) 190. CPU(s) 160 are configured to execute instructions such as executable instructions that perform one or more operations described herein, which may be stored in system memory 170. Local storage 180 may also optionally be aggregated and provisioned as a virtual storage area network (vSAN). NIC(s) 190 enable host 100 to communicate with other devices over a physical network (not shown).

Each CPU 160 includes one or more cores 162, memory management units (MMUs) 164, and TLBs 166. Each core 162 is a microprocessor such as an x86 microprocessor. Each MMU 164 is a hardware unit that supports “paging” of system memory 170. Paging provides a virtual memory environment in which a virtual address space is divided into pages, each page being an individually addressable unit of memory. Each page further includes a plurality of separately addressable data words, each of which includes one or more bytes of data. Pages are identified by addresses referred to as “page numbers.” CPU(s) 160 can support multiple page sizes including 4-KB, 2-MB, and 1-GB page sizes.

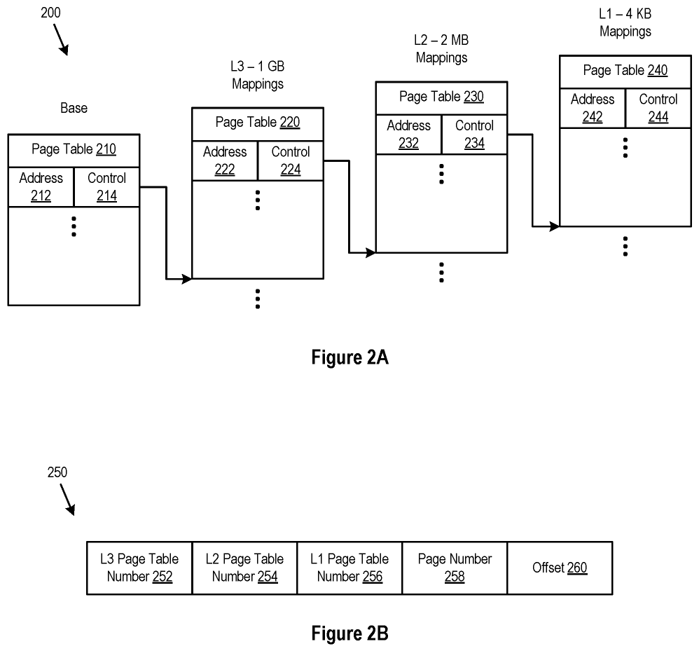

Page tables provide a mapping from the virtual address space to physical address space. Page tables are arranged in a hierarchy that may include various levels. Each page table includes entries, each of which specifies control information and a reference to either another page table or to a memory page. The hierarchy and individual structures of page tables will be described further below in conjunction with FIG. 2A. In the example shown in FIG. 1, guest page tables 116 are used to translate guest virtual addresses to guest physical addresses or guest physical page numbers (referred to herein as PPNs), i.e., addresses that appear to be physical memory addresses from the perspective of a VM 110 but that are actually virtual addresses from the perspective of host computer 100. Nested page tables 134 are used to translate PPNs to physical memory addresses or machine page numbers (referred to herein as MPNs) of system memory 170. A guest OS 114 and hypervisor 120 expose their respective page tables to CPU(s) 160.

MMU(s) 164 traverse or “walk” the page tables to translate virtual page numbers to physical page numbers, from guest virtual addresses to PPNs using guest page tables 116 and from PPNs to MPNs using nested page tables 134. TLB(s) 166 are caches that store full address translations for MMU(s) 164 from guest virtual addresses to MPNs. A CPU 160 may contain an MMU 164 and a TLB 166 for each core 162. If valid and present, an MMU 164 obtains a translation from a guest virtual address to an MPN directly from a TLB 166. Otherwise, an MMU 164 traverses the page tables to obtain the translation.

Software platform 102 includes a hypervisor 120, which is a virtualization software layer that abstracts hardware resources of hardware platform 104 for concurrently running VMs 110. One example of a hypervisor 120 that may be used is a VMware ESX® hypervisor by VMware, Inc. Each VM 110 includes one or more applications 112 running on a guest OS 114 such as a Linux® distribution. Guest OS 114 maintains guest page tables 116 for each of the applications running thereon.

Hypervisor 120 includes a kernel 130, VM monitors (VMMs) 140, and a VM migration module 150. Kernel 130 provides OS functionalities such as file system, process creation and control, and process threads. Kernel 130 also provides CPU and memory scheduling across VMs 110, VMMs 140, and VM migration module 150. During migration of VM 110 to a destination host computer, kernel 130 of the destination host computer maintains backing metadata 132. Backing metadata 132 includes MPNs of system memory 170 at which migrated memory pages are stored, and associates these MPNs to PPNs of the migrated memory pages. Backing metadata 132 also includes flags indicating types and properties of such migrated memory pages. Kernel 130 of the destination host computer also maintains nested page tables 134 for VMs 110, as discussed further below.

VMMs 140 implement the virtual system support needed to coordinate operations between VMs 110 and hypervisor 120. Each VMM 140 manages a virtual hardware platform for a corresponding VM 110. Such a virtual hardware platform includes emulated hardware such as virtual CPUs (vCPUs) and guest physical memory.

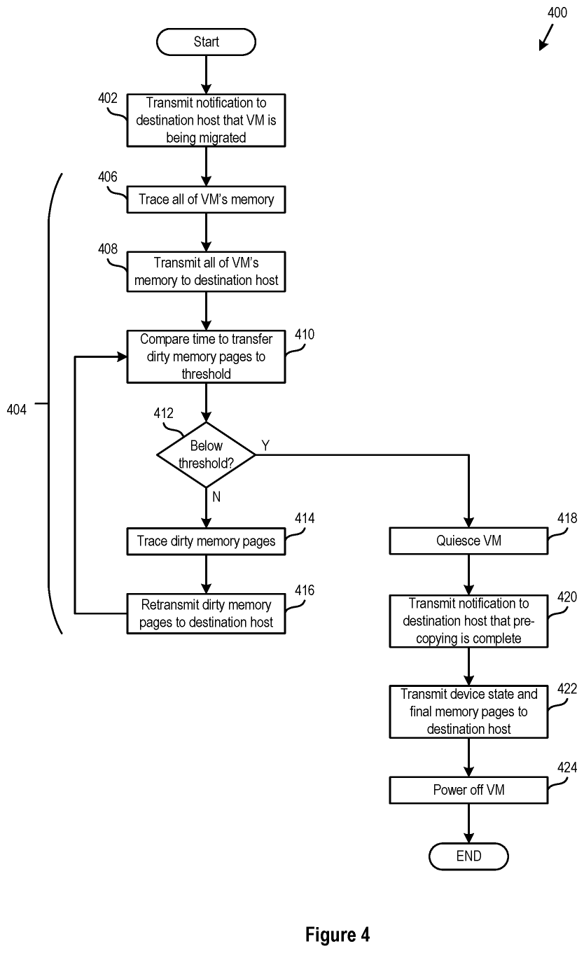

VM migration module 150 manages migrations of VMs 110 between host computer 100 and other host computers. VMMs 140 and VM migration module 150 include write traces metadata 142 and “dirty” pages metadata 152, respectively, which are used for detecting modified memory pages during migration of VM 110 from host computer 100. Metadata 142 and 152 are described further below in conjunction with FIG. 4.

FIG. 2A is a block diagram of memory page tables in a page table hierarchy 200, according to embodiments. In the example of FIG. 2A, page table hierarchy 200 is a four-level hierarchy such as can be configured for use by CPU(s) 160 of FIG. 1. However, page table hierarchies may include more or less than four levels. Furthermore, page table hierarchy 200 could correspond to either of guest page tables 116 or nested page tables 134.

Page table hierarchy 200 includes a base page table 210, level 3 (L3) page tables 220, level 2 (L2) page tables 230, and level 1 (L1) page tables 240. L3 includes a number of page tables 220 corresponding to the number of page table entries (PTEs) in base page table 210, e.g., 512 L3 page tables 220. L2 includes a number of page tables 230 corresponding to the product of the number of PTEs per L3 page table 220 and the total number of L3 page tables 220, e.g., 512×512=512² L2 page tables 230. L1 includes a number of page tables 240 corresponding to the product of the number of PTEs per L2 page table 230 and the total number of L2 page tables 230, e.g., 512×512²=512³ L1 page tables 240.

In the example of FIG. 2A, each PTE of L1 page tables 240 controls a 4-KB memory region, i.e., contains an address 242 that is either a PPN corresponding to a 4-KB VM memory page in the case of guest page tables 116 or an MPN corresponding to a 4-KB VM memory page in the case of nested page tables 134. Each PTE of the L2 page tables 230 controls a 2-MB memory region, i.e., contains an address 232 of an L1 page table 240 containing 512 4-KB PTEs. Each PTE of the L3 page tables 220 controls a 1-GB memory region, i.e., contains an address 222 of an L2 page table 230 containing 512 2-MB PTEs. As such, in the example of FIG. 2A, a virtual address space is divided into 4-KB pages. However, for example, in the case of a virtual address space that is divided into 2-MB pages, PTEs in the L2 page tables 230 may contain PPNs or MPNs corresponding to 2-MB VM memory pages. Furthermore, page table hierarchy 200 may also be configured with different page sizes at each level.

Each PTE of page table hierarchy 200 also includes various control bits. Control bits may include flags such as a “present” flag indicating whether a mapping is present, a “dirty” flag indicating whether a translation is performed in response to a write instruction, and a “PS” flag indicating whether a PTE maps to a page table or to a memory page. For example, the control bits 244 of PTEs in L1 page tables 240 may contain PS flags that are set, indicating that such PTEs contain either PPNs or MPNs. On other hand, the control bits 214, 224, and 234 of PTEs in base page table 210, L3 page tables 220, and L2 page tables 230 may contain PS flags that are unset, indicating that such PTEs contain addresses of other page tables.

FIG. 2B is a block diagram illustrating an example of an address 250 that may be used to walk memory page tables, according to embodiments. Address 250 is formatted for the four-level page table hierarchy 200 shown in the example of FIG. 2A.

Within address 250, an L3 page table number 252 selects a PTE in base page table 210 that points to an L3 page table 220. An L2 page table number 254 selects a PTE in an L3 page table 220 that points to one of L2 page tables 230. An L1 page table number 256 selects a PTE in an L2 page table 230 that points to one of L1 page tables 240. A page number 258 selects a PTE in an L1 page table 240 that contains a PPN or MPN corresponding to a 4-KB VM memory page. An offset 260 specifies a position within a selected 4-KB VM memory page. However, for example, in the case of a virtual memory space that is instead divided into 2-MB pages, the L1 page table number 256 may be eliminated, the page number 258 may select a PTE in an L2 page table 230 that contains a PPN or MPN corresponding to a 2-MB VM memory page, and the offset 260 may specify a position within a selected 2-MB VM memory page.

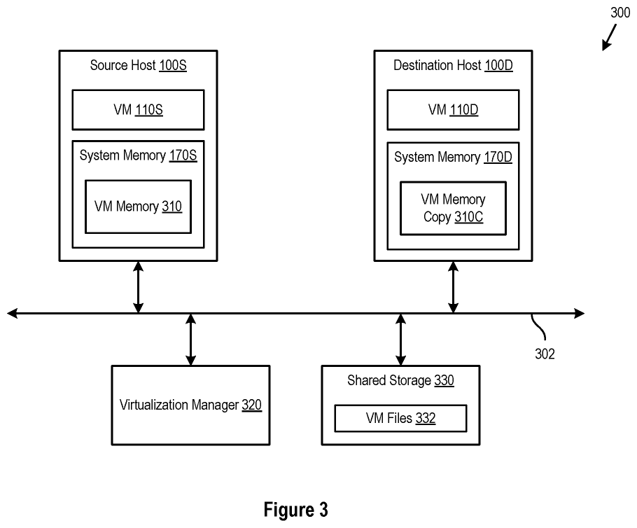

FIG. 3 is a block diagram of a virtualized computing system 300 in which a VM may be migrated from a source host 100S to a destination host 100D, according to embodiments. Host computer 100S includes a VM 110S and system memory 170S. VM 110S manages a portion of system memory 170S referred to as VM memory 310. Source host 100S is connected by a network 302 to destination host 100D to which VM 110S is to be migrated. Network 302 may be, e.g., a physical network that enables communication between hosts 100S and 100D and between other components and hosts 100S and 100D.

Virtualized computing system 300 further includes a virtualization manager 320 and shared storage 330. Virtualization manager 320 performs administrative tasks such as managing hosts 100S and 100D, provisioning and managing VMs therein, migrating VM 110S from source host 100S to destination host 100D, and load balancing between hosts 100S and 100D. Virtualization manager 320 may be a computer program that resides and executes in a central server or, in other embodiments, a VM executing in one of hosts 100S and 100D. One example of a virtualization manager 320 is the VMware vCenter Server® by VMware, Inc.

After migration of VM 110S from source host 100S to destination host 100D, VM 110S runs as VM 110D in destination host 100D. The image of VM 110D in system memory 170D is depicted as VM memory copy 310C, which is a copy of VM memory 310. Shared storage 330 accessible by host 100S and host 100D includes VM files 332, which include, e.g., application and guest OS files. Although the example of FIG. 3 includes VM files 332 in shared storage 330, the techniques described herein can also be employed in VM migrations in which each host accesses VM files on separate storage systems. In such an embodiment, VM files 332 are copied from a source storage system to a destination storage system.

FIG. 4 is a flow diagram of steps carried out by a source host to perform a method 400 of migrating a VM, according to embodiments. Method 400 will be explained with reference to source and destination hosts 100S and 100D of FIG. 3, and the VM migration module 150 of source host 100S will be referred to as “source VM migration module” 150.

At step 402, source VM migration module 150 transmits a notification to destination host 100D that VM 110S is being migrated. At step 404, source VM migration module 150 executes an iterative pre-copying of VM memory 310 from source host 100S to destination host 100D. The pre-copying spans steps 406-416. During the pre-copying phase, VM 110S continues executing at source host 100S and can modify memory pages that have already been copied to destination host 100D. Source VM migration module 150 tracks modified pages of VM memory 310 between iterations of pre-copying, such modified memory pages also referred to as “dirty” memory pages.

At step 406, source VM migration module 150 installs “write traces” on all pages of VM memory 310 to track which memory pages are subsequently dirtied. The installation of write traces is further described in U.S. patent application Ser. No. 17/002,233, filed Aug. 25, 2020, the entire contents of which are incorporated herein by reference. VMM 140 in source host 100S maintains write traces metadata 142 which identify the pages of VM memory 310 that are being traced. When VM 110S writes to a traced memory page, source VM migration module 150 is notified, which is referred to as a “trace fire,” and source VM migration module 150 tracks such pages as “dirty” in dirty pages metadata 152. Alternative to write tracing, source VM migration module 150 sets “read-only” flags in PTEs referencing pages of VM memory 310 to track which memory pages are subsequently dirtied. When VM 110S writes to any read-only page, a fault is triggered, and the fault handler notifies source VM migration module 150 that the read-only page has been written to. In response, source VM migration module 150 tracks such pages as “dirty” in dirty pages metadata 152. At step 408, source VM migration module 150 transmits all pages of VM memory 310 to destination host 100D along with PPNs of such pages. VM memory 310 is transmitted in units of 4-KB pages, although larger page sizes can be used.

At step 410, source VM migration module 150 accesses dirty pages metadata 152 to determine how many pages of VM memory 310 have been dirtied since the last installation of write traces, e.g., while VM memory 310 was being transmitted to destination host 100D, and compares the amount of time it would take to retransmit these dirty pages to a defined threshold. The amount of time depends on both the total size of the dirty pages and the transmission bandwidth. At step 412, if the amount of time is not below the threshold, method 400 moves to step 414, and source VM migration module 150 re-installs write traces on the dirty pages of VM memory 310. Source VM migration module 150 does not re-install write traces on the other pages of VM memory 310. At step 416, source VM migration module 150 retransmits the dirty pages of VM memory 310 to destination host 100D along with PPNs of such pages.

After step 416, method 400 returns to step 410, and source VM migration module 150 accesses dirty pages metadata 152 to determine how many pages of VM memory 310 have been dirtied since the last installation of write traces (e.g., at step 414) and compares the amount of time it would take to retransmit these dirty pages to the defined threshold. Steps 414 and 416 are repeated for the dirty pages indicated in dirty pages metadata 152 and the method loops back to step 410 if it is determined at step 412 that the amount of time it would take to retransmit these dirty pages is not below the threshold.

At step 412, if the amount of time it would take to retransmit the dirty pages is below the threshold, source VM migration module 150 “quiesces” VM 110S at step 418, at which point VM 110S is no longer running and thus no longer modifying VM memory 310. At step 420, source VM migration module 150 transmits a notification to destination host 100D indicating that pre-copying is complete. At step 422, source VM migration module 150 transmits the device state of VM 110S to destination host 100D including the states of any virtual devices used by VM 110S. Source VM migration module 150 also transmits a final set of dirty pages indicated in dirty pages metadata 152 to destination host 100D. At step 424, VM 110S is powered off, and method 400 ends.

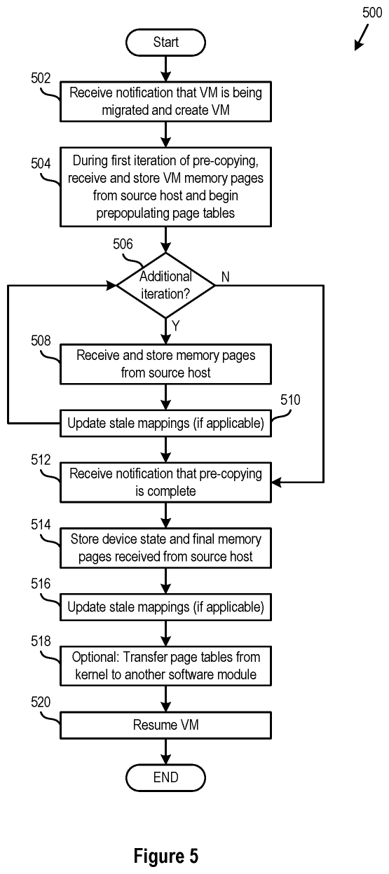

FIG. 5 is a flow diagram of steps carried out by a destination host to perform a method 500 of migrating a VM, according to embodiments. Method 500 will be explained with reference to source and destination hosts 100S and 100D of FIG. 3, and the VM migration module 150 of destination host 100D will be referred to as “destination VM migration module” 150.

At step 502, destination VM migration module 150 receives notification from source host 100S that VM 110S is being migrated. In response, destination VM migration module 150 creates a VM 110 on destination host 100D, e.g., VM 110D. At step 504, during a first iteration of pre-copying, destination VM migration module 150 receives each page of VM memory 310 from source host 100S and stores the memory pages in system memory 170D. Destination VM migration module 150 also updates backing metadata 132 to associate the MPNs of system memory 170D where the pages of VM memory 310 received from source host 100S are stored with PPNs of such pages. Thereafter, as dirty pages of VM memory 310 are received from source host 100S, destination VM migration module 150 accesses backing metadata 132 to determine the MPNs corresponding to the PPNs of the received dirty pages and stores the dirty pages at the locations in system memory 170D corresponding to these MPNs.

Additionally, at step 504, kernel 130 of destination host 100D begins prepopulating nested page tables 134 according to the PPNs and MPNs of backing metadata 132. During the first iteration of pre-copying, kernel 130 has time to store mappings for each memory page received from source host 100S. At step 506, if there is another iteration of pre-copying, i.e., if the time required for source host 100S to retransmit dirty memory pages is greater than the defined threshold, method 500 moves to step 508. At step 508, destination VM migration module 150 receives dirty pages of VM memory 310 from source host 100S and stores the dirty memory pages in system memory 170D. Specifically, destination VM migration module 150 determines the MPNs associated with the PPNs of dirty memory pages with reference to backing metadata 132, and stores the contents of the dirty memory pages at the locations in system memory 170D corresponding to these MPNs.

However, in some cases, a dirty page of VM memory 310 may correspond to an MPN of system memory 170D that is shared between multiple pages. In response to receiving the dirty memory page, instead of storing the contents at the corresponding MPN, the contents are stored at a new MPN, and backing metadata 132 is updated to associate the PPN of the memory page with its new MPN. One situation in which MPNs may be shared involves “zero pages,” i.e., memory pages that only contain zeros. As a memory-saving measure, PPNs of the zero pages may be mapped to a shared MPN of system memory 170D that only contains zeros.

At step 510, kernel 130 of destination host 100D updates any stale mappings. For example, if kernel 130 detects that a PPN has been updated from being associated with an MPN of a shared page to being associated with a new MPN, kernel 130 updates nested page tables 134 to map the PPN to the new MPN. Additionally, there may be memory pressure at destination host 100D in which system memory 170D is low on free space. To free up space, some large pages of VM 110D may be broken up into pluralities of smaller pages so that at least some space within the large pages can be reclaimed. In response to detecting such changes, kernel 130 updates PTEs in nested page tables 134 corresponding to the large pages.

For example, an L1 page table may be created that includes pointers to at least some of a plurality of smaller pages from a large page that is broken up. Then, a PTE of an L2 page table corresponding to the large page is updated from pointing to an address of system memory 170D, to pointing to the newly created L1 page table. On the other hand, instead of an L1 page table immediately being created, mappings to the plurality of smaller pages may be created later on demand. In such a case, the present flag of the PTE in the L2 page table is cleared, indicating that the large page is no longer present in system memory 170D.

After step 510, method 500 returns to step 506. At step 506, if there are no additional iterations of pre-copying, i.e., if the time required for source host 100S to transfer dirty memory pages falls below the threshold, method 500 moves to step 512. At step 512, destination VM migration module 150 receives notification from source host 100S that pre-copying has completed. At step 514, destination VM migration module 150 receives the device state of VM 110S and a final set of dirty pages of VM memory 310 along with their PPNs. Destination VM migration module 150 then stores the device state of VM 110S in system memory 170D, determines the MPNs associated with the PPNs of dirty pages with reference to backing metadata 132, and stores the contents of the dirty pages at the locations in system memory 170D corresponding to these MPNs.

At step 516, kernel 130 of destination host 100D updates any stale mappings. At step 518, as an optional step, kernel 130 transfers prepopulated nested page tables 134 to another software module, e.g., VMM 140 corresponding to VM 110D. VMM 140 may thus maintain nested page tables 134 after kernel 130 performs prepopulating. Otherwise, kernel 130 continues maintaining nested page tables 134 after prepopulating them. At step 520, the VM is resumed as VM 110D. After step 520, method 500 ends, and VM 110D continues executing on destination host 100D.

Although method 500 includes separate steps 508 and 510, the step of receiving and storing memory pages during an iteration of pre-copying may be performed in conjunction with the step of updating of stale mappings in nested page tables 134. As such, nested page tables 134 may be updated immediately in response to a mapping therein becoming stale instead of such updating being performed after all the memory pages of an iteration of pre-copying have been received and stored in system memory 170D. Similarly, although method 500 includes separate steps 514 and 516, the step of receiving and storing device state and final memory pages may be performed in conjunction with updating of stale mappings.

The embodiments described herein employ various techniques of tracking memory pages that are accessed during migration of VM 110S to intelligently prepopulate nested page tables 134 at destination host 100D. Other techniques may also be utilized in other applications for accomplishing the goal of prepopulating nested page tables 134 to improve the responsiveness of a VM. For example, in the case of reconfiguring an existing VM 110, a new VM 110 may be created on the same host 100. As such, the original VM 110's nested page tables 134, which mostly remain unchanged, may be transferred to the new VM 110. Additionally, in the case of “instant cloning” a VM 110, a clone of an existing VM 110 may be created on the same host 100. As such, nested page tables 134 for the new VM 110 may be prepopulated using mappings from the nested page tables 134 of the original VM 110.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data that can thereafter be input into a computer system. Computer readable media may be based on any existing or subsequently developed technology that embodies computer programs in a manner that enables a computer to read the programs. Examples of computer readable media are HDDs, SSDs, network-attached storage (NAS) systems, read-only memory (ROM), RAM, compact disks (CDs), digital versatile disks (DVDs), magnetic tapes, and other optical and non-optical data storage devices. A computer readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest OS that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of populating page tables of an executing workload during migration of the executing workload from a source host to a destination host, the method comprising:
during transmission of memory pages of the executing workload from the source host to the destination host, populating the page tables of the workload at the destination host, wherein the populating comprises inserting mappings from virtual addresses of the workload to physical addresses of system memory of the destination host for all of the memory pages of the executing workload; and
upon completion of transmission of all of the memory pages of the workload, resuming the workload at the destination host.

2. The method of claim 1, wherein the workload is a virtual machine (VM), and the page tables of the executing workload are nested page tables that store mappings from guest physical addresses of the VM to physical addresses of the system memory.

3. The method of claim 2, wherein the virtual addresses are transmitted from the source host to the destination host.

4. The method of claim 1, wherein the populating of the page tables is performed by a kernel of a virtualization software layer that abstracts hardware resources of a hardware platform of the destination host for the VM.

5. The method of claim 4, further comprising:
upon completion of populating the page tables, transferring the page tables from the kernel of the virtualization software layer to another software module that is separate from the kernel.

6. The method of claim 1, further comprising:
before resuming the workload at the destination host, detecting that a memory page for which a mapping has already been inserted into the page tables is stored at an updated physical address of the system memory; and
in response to detecting the memory page being stored at the updated physical address, updating the mapping of the memory page to include the updated physical address.

7. The method of claim 1, further comprising:
before resuming the workload at the destination host, detecting that a first memory page for which a mapping has already been inserted into the page tables has been broken up into a plurality of second memory pages; and
in response to detecting the breaking up of the first memory page, selecting an entry of a first page table, wherein the entry corresponds to the first memory page and includes a pointer to the system memory, and executing one of:
updating the pointer to the system memory to point to a second page table, wherein the second page table includes entries with pointers to at least some of the plurality of second memory pages, and
clearing a flag of the entry of the first page table, indicating that the first memory page is no longer present in the system memory.

8. A non-transitory computer readable medium comprising instructions that are executable by a destination host, wherein the instructions when executed cause the destination host to carry out a method of populating page tables of an executing workload during migration of the executing workload from a source host to the destination host, the method comprising:
during transmission of memory pages of the executing workload from the source host to the destination host, populating the page tables of the workload at the destination host, wherein the populating comprises inserting mappings from virtual addresses of the workload to physical addresses of system memory of the destination host for all of the memory pages of the executing workload; and
upon completion of transmission of all of the memory pages of the workload, resuming the workload at the destination host.

9. The non-transitory computer readable medium of claim 8, wherein the workload is a virtual machine (VM), and the page tables of the executing workload are nested page tables that store mappings from guest physical addresses of the VM to physical addresses of the system memory.

10. The non-transitory computer readable medium of claim 9, wherein the virtual addresses are transmitted from the source host to the destination host.

11. The non-transitory computer readable medium of claim 8, wherein the populating of the page tables is performed by a kernel of a virtualization software layer that abstracts hardware resources of a hardware platform of the destination host for the VM.

12. The non-transitory computer readable medium of claim 11, the method further comprising:
upon completion of populating the page tables, transferring the page tables from the kernel of the virtualization software layer to another software module that is separate from the kernel.

13. The non-transitory computer readable medium of claim 8, the method further comprising:
before resuming the workload at the destination host, detecting that a memory page for which a mapping has already been inserted into the page tables is stored at an updated physical address of the system memory; and
in response to detecting the memory page being stored at the updated physical address, updating the mapping of the memory page to include the updated physical address.

14. The non-transitory computer readable medium of claim 8, the method further comprising:
before resuming the workload at the destination host, detecting that a first memory page for which a mapping has already been inserted into the page tables has been broken up into a plurality of second memory pages; and
in response to detecting the breaking up of the first memory page, selecting an entry of a first page table, wherein the entry corresponds to the first memory page and includes a pointer to the system memory, and executing one of:
updating the pointer to the system memory to point to a second page table, wherein the second page table includes entries with pointers to at least some of the plurality of second memory pages, and
clearing a flag of the entry of the first page table, indicating that the first memory page is no longer present in the system memory.

15. A computer system comprising:
a source host; and
a destination host configured to carry out a method of populating page tables of an executing workload during migration of the executing workload from the source host to the destination host, the method comprising:
during transmission of memory pages of the executing workload from the source host to the destination host, populating the page tables of the workload at the destination host, wherein the populating comprises inserting mappings from virtual addresses of the workload to physical addresses of system memory of the destination host for all of the memory pages of the executing workload, and
upon completion of transmission of all of the memory pages of the workload, resuming the workload at the destination host.

16. The computer system of claim 15, wherein the workload is a virtual machine (VM), and the page tables of the executing workload are nested page tables that store mappings from guest physical addresses of the VM to physical addresses of the system memory.

17. The computer system of claim 15, wherein the populating of the page tables is performed by a kernel of a virtualization software layer that abstracts hardware resources of a hardware platform of the destination host for the VM.

18. The computer system of claim 17, the method further comprising:
upon completion of populating the page tables, transferring the page tables from the kernel of the virtualization software layer to another software module that is separate from the kernel.

19. The computer system of claim 15, the method further comprising:
before resuming the workload at the destination host, detecting that a memory page for which a mapping has already been inserted into the page tables is stored at an updated physical address of the system memory, and
in response to detecting the memory page being stored at the updated physical address, updating the mapping of the memory page to include the updated physical address.

20. The computer system of claim 15, the method further comprising:
before resuming the workload at the destination host, detecting that a first memory page for which a mapping has already been inserted into the page tables has been broken up into a plurality of second memory pages, and
in response to detecting the breaking up of the first memory page, selecting an entry of a first page table, wherein the entry corresponds to the first memory page and includes a pointer to the system memory, and executing one of:
updating the pointer to the system memory to point to a second page table, wherein the second page table includes entries with pointers to at least some of the plurality of second memory pages, and
clearing a flag of the entry of the first page table, indicating that the first memory page is no longer present in the system memory.
